(19) United States
(12) Patent Application Publication
(10) Pub. No.: US 2024/0410103 A1
(43) Pub. Date: Dec. 12, 2024

(54) Sensor system for a liquid-carrying household appliance and household appliance with the sensor system

(71) Applicant: emz-Hanauer GmbH & Co. KGaA, Nabburg (DE)

(72) Inventors: Lukas Schade, Nabburg (DE); Manfredi Signorino, Wackersdorf (DE); Georg Spießl, Altendorf (DE); Johann Kleber, Nabburg (DE)

(21) Appl. No.: 18/675,681

(22) Filed: May 28, 2024

(30) Foreign Application Priority Data
Jun. 12, 2023 (DE) 102023115244.0
Feb. 29, 2024 (DE) 102024105827.7

(51) Int. Cl. D06F 39/08; D06F 34/08; D06F 34/20; D06F 34/22; D06F 37/26; D06F 39/02; D06F 103/18; D06F 103/36; D06F 105/00; G01F 23/24

(52) U.S. Cl. CPC D06F 39/087; D06F 34/08; D06F 34/20; D06F 34/22; D06F 37/26; D06F 39/022; G01F 23/241; D06F 2103/18; D06F 2103/36; D06F 2105/00

(57) ABSTRACT

A sensor system for a liquid-carrying household appliance, in particular a washing machine, wherein the sensor system comprises at least one detection element for detecting a heat flow and is designed to arrange the at least one detection element in the household appliance next to a room area designed to hold a liquid in such a way that the at least one detection element can detect a heat flow between the at least one detection element and the room area, which indicates a fill level of liquid, in particular washing liquid, in the room area.

### CROSS-REFERENCE TO RELATED APPLICATIONS

This patent application claims the benefit of and priority to German Patent Application No. 102024105827.7, filed on Feb. 29, 2024, and German Patent Application No. 102023115244.0, filed on Jun. 12, 2023. Each of these patent applications is herein incorporated by reference in its entirety.

### FIELD OF THE DISCLOSURE

The invention relates to a sensor system for a liquid-carrying household appliance, and with a household appliance having the same sensor system.

### BACKGROUND

It is known to use optical sensors or ultrasonic sensors to measure the level of a liquid in a container. The level of a liquid in a room area can also be of interest in liquid-carrying household appliances such as washing machines, dishwashers and ice makers. In the case of a washing machine, the room area that can be filled with liquid can be enclosed by a detergent container, in the case of a dishwasher by a crockery or rinse aid container and in the case of an ice maker by a water storage container. As household appliances are mass-produced goods that are manufactured in millions of units, the costs for any sensors for level measurement should be kept as low as possible. For this reason, the above-mentioned level measurement sensors are unsuitable for use in household appliances.

### SUMMARY

It is a task of the invention to provide a cost-effective sensor system for a liquid-carrying household appliance that enables a liquid level to be determined.

According to the invention, a sensor system according to claim 1 and a household appliance comprising such a sensor system are provided.

The sensor system comprises at least one detection element for detecting a heat flow and is designed to arrange the at least one detection element in the household appliance next to a room area designed to hold liquid in such a way that the at least one detection element can detect a heat flow between the at least one detection element and the room area, which indicates a fill level of liquid (e.g., detergent, dishwashing detergent, fresh or process water) in the room area. Instead of optical or acoustic detection of the fill level, the heat flow between the at least one detection clement and the room area can therefore be used to draw conclusions about the fill level of the liquid. If the room area next to the detection element is free of liquid (i.e., filled with gas), then waste heat from the detection element can be dissipated less quickly. If, on the other hand, the room area next to the detection element is filled with liquid, the waste heat can be dissipated more quickly. The detection elements that can be used to detect the heat flow are comparatively inexpensive.

In certain embodiments, the sensor system is designed to arrange the at least one detection element at a predetermined height next to the room area such that the at least one detection element can detect a heat flow between the at least one detection element and the room area that indicates whether the level falls below or exceeds the predetermined height. In other words, the at least one detection element can be assigned to the predetermined height and thus also to a predetermined fill level. In the event that the at least one detection element consists of several detection elements, the sensor system can be designed to arrange each detection element at a different height next to the room area. The detection elements can be arranged at regular intervals or heights next to the room area. The use of several detection elements with different predetermined heights can enable a more accurate determination of the level of the liquid, especially if each detection element is only used to determine whether the level is currently above or below the predetermined height assigned to the respective detection element.

In certain embodiments, the at least one detection element is set up to be heated and/or cooled by being supplied with electrical energy and to provide a measurement signal that indicates a temperature of the detection element. The at least one detection element can indicate the temperature by means of the electrical resistance of a resistor element, by means of a current flowing through the resistor element and/or by means of a voltage dropping across the resistor element. The measurement signal can therefore indicate a current electrical state (e.g., an electrical resistance, a current flowing through and/or a falling voltage) of the resistor element and/or detection element, a signal proportional to this current electrical state, or a currently measured temperature. In this way, the at least one detection element can be heated and/or cooled in a targeted manner with simultaneous detection of its temperature. The detection elements can detect the heat flow by providing a measurement signal that indicates temperatures at different times of a heating and/or cooling cycle.

In certain embodiments, the detection unit can be formed by a single electrical component, in particular the detection unit can be an (NTC or PTC) thermistor, a diode or a transistor. These measures also enable a particularly cost-effective sensor system.

In certain embodiments, the sensor system comprises a printed circuit board having a main section and at least one finger-shaped extension extending from the main section and carrying the at least one detection element. In this or other embodiments, the at least one finger-shaped extension is configured to extend from the main section of the printed circuit board towards the room area of the household appliance. Alternatively or additionally, two or more of the at least one finger-shaped extension may extend substantially parallel. In this way, the main section can be at least partially thermally decoupled from the at least one detection element, so that the detection element can dissipate a large part of its waste heat to the neighbouring room section rather than to the main section. In this way, a type and a change in the medium located in the room area next to the detection elements can be detected more quickly, which in turn allows the level of a liquid in the room area to be determined quickly and accurately.

In certain embodiments, the at least one detection element is arranged on a printed circuit board (e.g., the printed circuit board with the main section and the at least one finger-shaped extension) and forms a first resistor element of a voltage divider comprising at least two resistor elements, wherein one or more, in particular all, of the further resistor elements of the voltage divider are arranged separately from the printed circuit board. It is conceivable that the printed circuit board carries no other electrical component apart from the at least one detection element, but only one or more printed circuit board traces and an electrical interface, for example in the form of a plug contact. In this way, a particularly cost-effective printed circuit board can be provided.

In certain embodiments, the sensor system further comprises a separating wall, wherein the sensor system is configured to arrange the at least one detection element in the household appliance separated from the room area by the separating wall, wherein the separating wall optionally forms at least a part of a liquid container enclosing the room area. The sensor system can also include the liquid container. In this way, it can be ensured that the at least one detection element and/or the printed circuit board does not come into contact with a liquid in the room area. This enables the use of liquid-sensitive electrical components as detection elements and allows the use of exposed printed circuit board traces on the printed circuit board, which can further reduce the cost of the sensor system.

In certain embodiments, the separating wall has at least one protrusion which is formed in the direction of the room area, wherein the at least one detection element is arranged in the at least one protrusion. In particular, each protrusion can be designed to accommodate a respective finger-shaped extension of the printed circuit board. The at least one detection element can therefore be surrounded on several sides by the separating wall. This ensures that waste heat from the at least one detection element can be dissipated into the room area over as large an interface as possible. As a result, the heat flow between the at least one detection element and the room area is particularly strongly influenced by the medium in the room area, which ultimately enables more reliable detection of the fill level.

In certain embodiments, the sensor system further comprises a control unit that is set up to receive one or more measurement signals from the at least one detection element and to determine a value therefrom that indicates the heat flow detected by the at least one detection clement and/or the level of liquid in the room area. The control unit can be attached to the printed circuit board (e.g., arranged on the printed circuit board). Alternatively, it is conceivable that the control unit is electrically connected to the printed circuit board via a cable connection. In the latter case, the control unit can correspond to a central control unit of the household appliance. The provision of such a control unit enables the use of particularly simple and cost-effective detection elements, as the data processing is outsourced to the control unit common to all detection elements.

In certain embodiments, the control unit is set up to cause heating and/or cooling of the at least one detection element and to determine the value based on a temperature behaviour of the detection element indicated by the measurement signal(s). It is conceivable that the control unit heats the at least one detection element by supplying it with electrical energy, wherein the displayed temperature behaviour comprises a current electrical state of the at least one detection and/or resistor element (e.g., a through current through the corresponding element, a voltage currently dropping across the corresponding element and/or an electrical resistance of the corresponding element) and/or a current temperature of the at least one detection element at one or more predetermined points in time (e.g., before, after and/or during) the heating. Further, the control unit may terminate the heating of the at least one detection element at an end time, wherein the displayed temperature behaviour then comprises a current electrical state and/or a current temperature of the at least one detection element at one or more predetermined times after the end time. The control unit can be set up to determine a thermal inertia of the detection element based on the temperature behaviour indicated by the measurement signal(s), which in turn is influenced by the medium in the room area arranged next to the detection element, and to determine the value based on the thermal inertia. The control unit can thus cause an active temperature change of the at least one detection element and determine the value by analysing the temperature behaviour of the at least one detection element as a function of the time and/or the electrical energy provided for heating. Among other things, this makes it possible to detect a heat flow even if the at least one detection element and the medium in the room area initially have the same temperature.

According to a preferred embodiment, at least one detection element from a plurality of detection elements is operated as a reference detection element. The sensor system thus advantageously comprises at least two detection elements. Preferably, the detection element operated as a reference detection element is designed in the same way as the other detection elements. Advantageously, this at least one reference detection element detects a heat flow between the at least one reference detection clement and the room area. Alternatively or cumulatively, this at least one reference detection element detects a heat flow between the at least one reference detection element and an environment. Preferably, the at least one reference detection element is not intended to detect a heat flow between the at least one reference detection element and a liquid located in the room area. Preferably, the at least one reference detection element only detects a heat flow between the at least one reference detection clement and the medium, which is preferably air or a gas mixture, located in the room area instead of the liquid. Preferably, the reference detection element is arranged in such a way that a heat flow to the liquid is not possible. This can be achieved, for example, by placing it above a maximum fill level.

Preferably, a ratio or quotient of the measured value of the reference detection element and the measured value of the at least one further detection clement is formed during an evaluation.

According to another preferred embodiment, the sensor system comprises several detection elements which are connected in series. Preferably, the detection elements form resistor elements of a voltage divider with at least one further resistor element.

Advantageously, the current of this series connection is used for evaluation. Alternatively or cumulatively, a change in the current of this series connection is used for evaluation.

According to a further preferred embodiment, at least one resistor element is provided which is suitable and intended for heating the at least one detection element. Such a resistor element is also referred to as a heating resistor. If an electric current passes through an (ohmic) resistor element, heat is released and emitted to the environment. Advantageously, the at least one resistor element provided for heat dissipation is arranged spatially close to the at least one detection element. Preferably, the at least one resistor element provided for heat dissipation is in contact with the at least one detection element. This enables effective heat transfer. Advantageously, the at least one resistor element is connected in series or parallel to the at least one detection element.

There is also provided a household appliance, in particular a washing machine, which comprises the sensor system described herein. The liquid container defining the room area can either be permanently installed in the household appliance or can be removable from the household appliance. The printed circuit board can be attached to the liquid container. Alternatively, it is conceivable that the printed circuit board is attached to the household appliance in such a way that it is arranged in a predetermined position relative to the liquid container when the liquid container is installed, in particular so that the at least one finger-shaped extension comes to rest in the at least one protrusion.

### BRIEF DESCRIPTION OF THE DRAWINGS

The invention is further explained below with reference to the accompanying drawings. They show:

FIG. 1 a schematic view of a household washing machine according to an embodiment example;

FIG. 2 a sensor system according to an embodiment example;

FIG. 3 an example of an evaluation circuit;

FIG. 4 two exemplary measurement signals; and

FIG. 5 a schematic view of several possible arrangements of a detection element of a sensor system on a liquid container.

### DETAILED DESCRIPTION

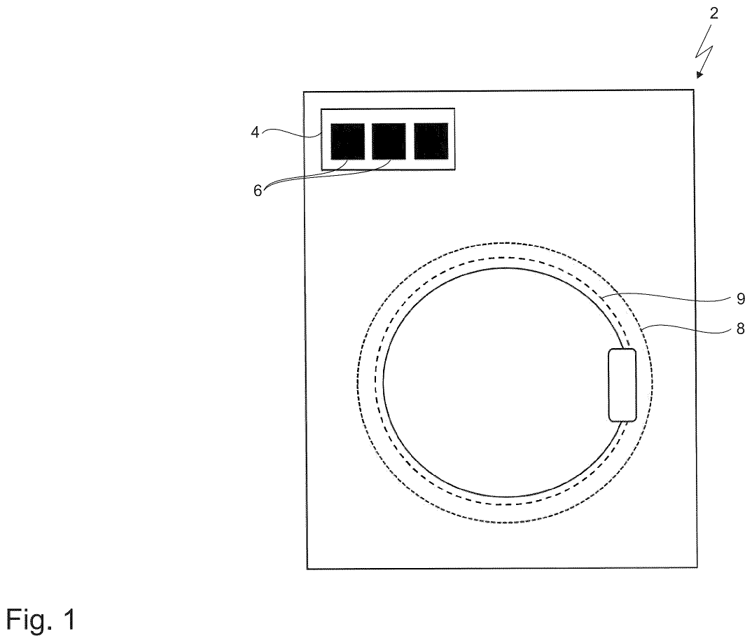

Firstly, referring to FIG. 1, a washing machine 2 is shown there as an example of a liquid-carrying household appliance. The washing machine 2 comprises a holding area 4 for holding one or more liquid containers 6. The liquid containers 6 can be removable from the holding area 4 or permanently installed in the washing machine 2. In this example, the liquid containers 6 are each designed to hold liquid detergent. The washing machine 2 further comprises a working tub 8 with a drum 9 for holding laundry. At the start of a wash cycle, the working tub 8 is at least partially filled with liquid, in particular with fresh water and/or detergent. After a while, contaminated process water is present in the working tub 8 due to the removal of dirt from the laundry. It can be advantageous to determine the fill level of liquid in different room areas of the washing machine 2. In particular, a current level of liquid detergent in the individual liquid containers 6 and/or a fill level of liquid in the working tub 8 may be of interest.

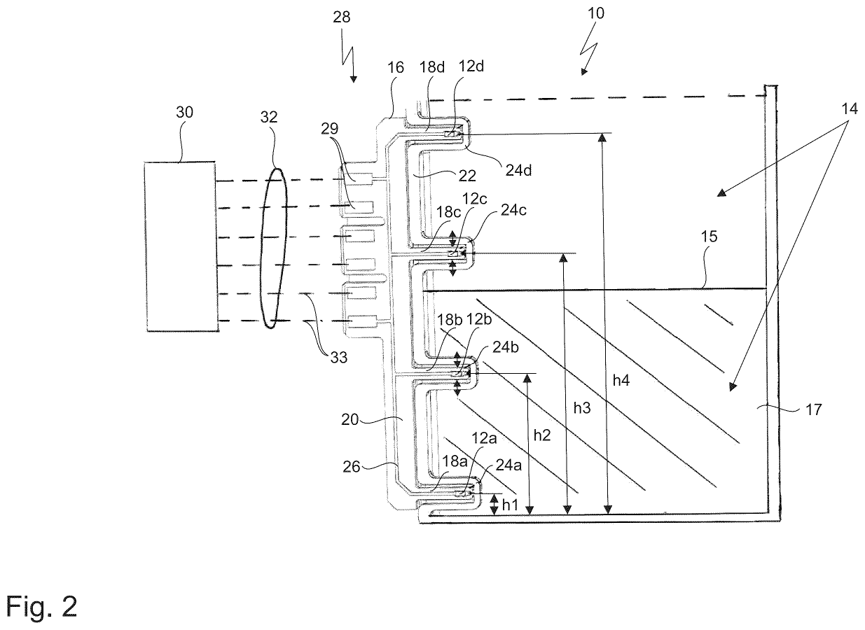

A sensor system 10 is provided for a liquid-carrying household appliance, in particular for the washing machine 2. As indicated in the embodiment example according to FIG. 2, the sensor system 10 comprises one or more detection elements 12 or 12a-12d, each of which is designed to detect a heat flow. In this case, the sensor system 10 is designed to arrange all detection elements 12 next to a room area 14 of the household appliance 2 designed to hold a liquid 17. This room area 14 may, for example, be the interior of one of the liquid containers 6 or the working tub 8. Due to this arrangement, the individual detection elements 12 can detect a heat flow that flows between the respective detection element 12 and the room area 14. In FIG. 2, the heat flow for the detection elements 12c and 12d is indicated by arrows. Since this heat flow is significantly influenced by a medium in the room area 14 next to the respective detection element 12, the respective heat flow indicates a current liquid level 15 in the room area 14. If the room area 14 next to a detection element 12 is filled with liquid 17, as in the case of the detection elements 12a, 12b, an amount of heat can be transferred more quickly between the corresponding detection element 12a, 12b and the room area 14 than if the room area 14 next to a detection element 12 is empty or filled with gas, as in the case of the detection elements 12c, 12d.

As can be seen in FIG. 2, the detection elements 12 can be arranged at different heights h1-h4 in relation to the room area 14. In the example case shown, the heat flows detected by the two lower detection elements 12a, 12b indicate that the liquid level 15 currently exceeds the installation heights h1, h2 of these two detection elements 12a, 12b. The heat flows detected by the two upper detection elements 12c, 12d, on the other hand, indicate that the liquid level 15 is currently below the installation heights h3, h4 of these two upper detection elements 12c, 12d. This enables multi-stage detection of the level 15 of the liquid 17 in the room area 14, even if each detection element 12 only allows binary detection of whether it is currently below or above the liquid level.

The one or more detection elements 12 can be designed such that they heat up when supplied with electrical heating power and/or cool down when supplied with electrical cooling power. It is conceivable that a detection element 12 comprises a heating and/or cooling element for this purpose, such as a heating resistor or a Peltier element. Each detection element 12 is designed such that it can provide a measurement signal that directly or indirectly indicates a temperature of the detection element. In particular, the detection element 12 may be formed by a single electrical component, for example an NTC or PTC thermistor, a diode or a transistor. The temperature of the detection element 12 can be indicated by a current electrical state of the same, in particular by its current electrical resistance, the current currently flowing through the detection element 12 and/or the voltage currently dropping across the detection element 12. The measurement signal can be proportional (e.g., directly, inversely, linearly or otherwise) to the current electrical state of the detection elements 12 or reflect the current electrical state.

In the embodiment example according to FIG. 2, the sensor system 10 comprises a (e.g., printed) circuit board 16 which is substantially planar. The printed circuit board 16 comprises a plurality of finger-shaped extensions 18 or 18a-18d extending away from a main section 20 of the printed circuit board 16. Each of these extensions 18 carries an individual detection element 12. In the example shown, the extensions 18 run parallel and extend from the main section 20 in the direction of the room area 14. The detection elements 12 are thus spaced apart from the main section 20 of the printed circuit board 16 in the direction of the room area 14.

The sensor system 10 further comprises a separating wall 22 arranged between the printed circuit board 16 and the room area 14. The room area 14 can be directly adjacent to the separating wall 22 as shown in FIG. 2. In particular, the separating wall 22 may be part of the liquid container 6. In the embodiment example according to FIG. 2, the separating wall 22 comprises a plurality of protrusions 24 or 24a-24d. Each of the protrusions 24 is designed to receive a single extension 18 of the printed circuit board 16. Each protrusion 24 thus encloses a respective extension 18 with the detection elements 12 arranged thereon. The separating wall 22 can be made of plastic, in particular injection-moulded plastic, and have a wall thickness of a few millimetres or a few hundred micrometres, in particular in the area of the protrusions 24. The respective detection element 12 is thus surrounded in several spatial directions by the separating wall 22 and by the room area 14. This ensures that a large amount of waste heat is transferred from the detection elements 12 towards the room area 14 instead of towards the main section 20, which ultimately allows a more reliable detection of the liquid level 15 in the room area 14.

On the printed circuit board 16, printed circuit board traces 26 can be provided for electrical contacting of the detection elements 12. Since the separating wall 22 ensures that no liquid 17 from the room area 14 reaches the printed circuit board 16, these printed circuit board traces 26 can be exposed or uninsulated. The printed circuit board 16 may comprise an electrical interface 28 to which the printed circuit board traces 26 are connected. In particular, the electrical interface 28 can be designed as a plug contact. In the embodiment example shown, the electrical interface 28 is further away from the room area 14 than the extensions 18, or the interface 28 is arranged on a different side of the main section 20 than the detection elements 12.

The sensor system 10 may also comprise a control unit 30. The control unit 30 may be attached to the printed circuit board 16. In particular, the control unit 30 comprises a microcontroller arranged on the printed circuit board 16. Alternatively, the control unit 30 may be connected to the printed circuit board 16 via a cable connection 32, as indicated in FIG. 2. In this case, the control unit 30 can be part of a central control unit of the household appliance 2, which is used to control functions of the household appliance 2, for example to control pumps and/or motors of the household appliance 2 during a wash cycle, in particular on the basis of a value determined by the control unit 30, which indicates a heat flow detected by the respective detection elements 12 and/or the level 15 of liquid 17 in the room area 14.

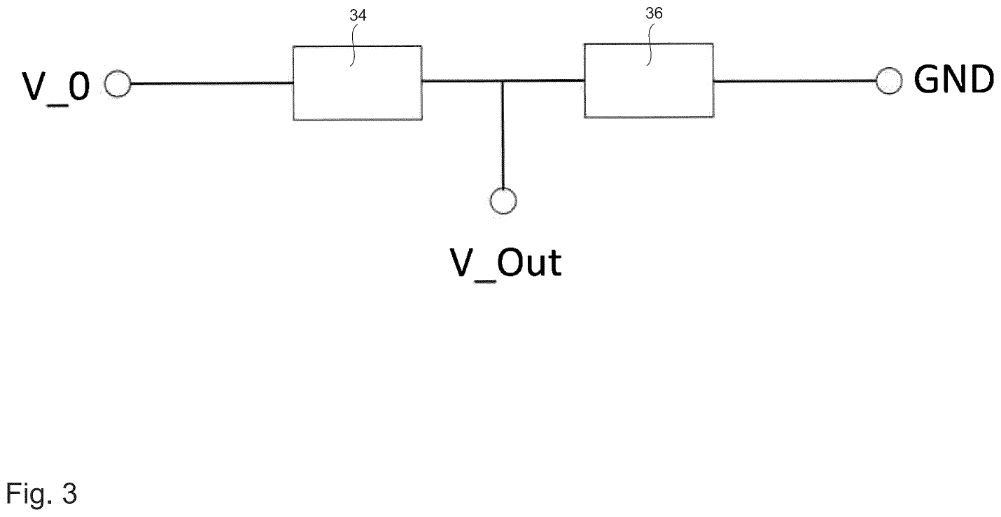

FIG. 3 shows an example of an evaluation circuit. The circuit represents a voltage divider with two resistor elements 34, 36. A first of these two resistor elements corresponds to a detection element 12, for example an NTC thermistor. It is understood that instead of an NTC thermistor, another electronic component can also be used which has a temperature-dependent electrical behaviour. A second of these two resistor elements can correspond to an electrical resistor or a group of several electrical resistors and possibly other electrical components. In particular, the second of the two resistor elements may have a lower temperature coefficient (i.e., a lower change in resistance as a function of temperature) than the first of the two resistor elements. The second of the two resistor elements may be arranged on the printed circuit board 16, in particular on the main section 20 of the printed circuit board 16. The first of the two resistor elements may correspond to the resistor element 34 of FIG. 3 and the second of the two resistor elements may correspond to the resistor element 36 of FIG. 3, or vice versa.

It is sufficient to supply the printed circuit board 16 with a uniform supply voltage V_0 or a uniform ground potential GND, and to tap the output voltage V_Out from each individual detection element 12. The same supply voltage V_0 and/or the same earthing potential GND can be provided for a group of detection elements 12, or for all detection elements 12, for example via the same wire 33 of the cable connection 32, the same electrical contact of the electrical interface 28 and/or the same printed circuit board trace 26 on the printed circuit board 16. On the other hand, the measurement signal in the form of the voltage V_Out should be able to be transmitted individually for each detection element (i.e., a separate wire 33 of the cable connection 32, a separate electrical contact 29 and/or a separate printed circuit board trace 26 on the printed circuit board 16 should be provided for each detection element 12).

In an advantageous embodiment example, the second of the two resistor elements is arranged separately from the printed circuit board 16, for example as part of the control unit 30. In other words, the sensor system 10 may be designed such that the electrical interface 28 comprises a total number G of electrical contacts 29 for which, with respect to the total number D of detection elements 12, the following applies: G≤3*D or G≤2*D or G≤1.5*D or G≤D+2 or G≤D+1. The same applies to the total number Z of wires 33 of the cable connection 32 that are necessary to connect the control unit 30 to the printed circuit board 16 (i.e., G=Z) and/or to the total number L of separate printed circuit board traces 26 on the printed circuit board 16 (i.e., G=L).

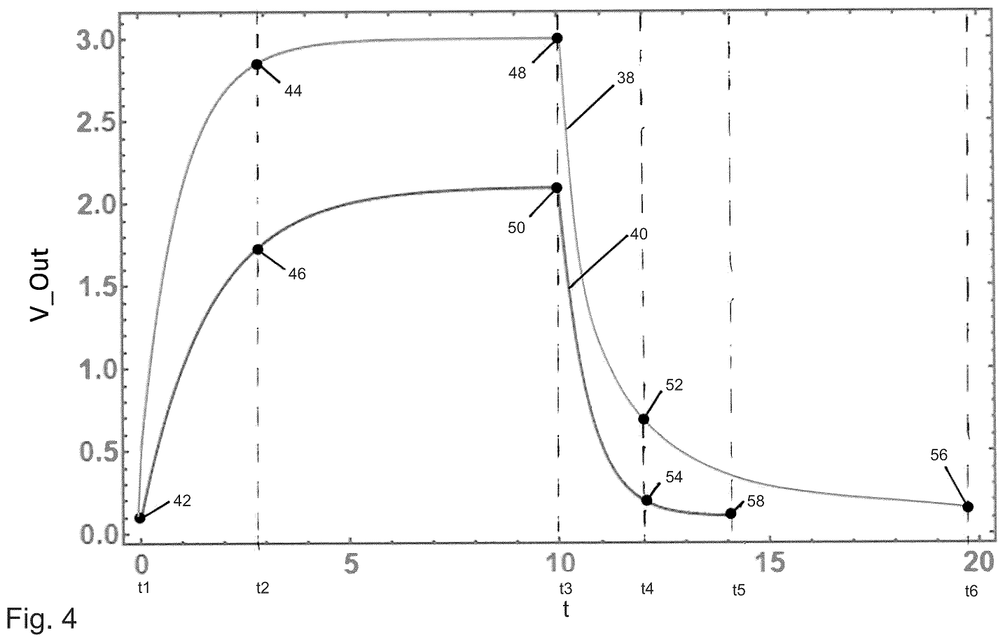

The control unit 30 can be designed to receive the output voltage V_Out of each detection element 12 as measurement signals. Based on these measurement signals, the control unit 30 can determine a value that indicates a heat flow detected by the respective detection elements 12 and/or the level 15 of liquid 17 in the room area 14. FIG. 4 shows two exemplary curves 38, 40, which represent different measurement signals. The curve 38 represents the voltage V_Out at a detection element 12 in the event that there is no liquid 17 in the room area 14 next to the corresponding detection element 12. The curve 40, on the other hand, represents the voltage V_Out at the same detection element 12 in the event that there is liquid in the room area 14 next to the detection element 12.

In the period 0<t<10, the control unit 30 applies electrical heating power to the detection element 12 so that the detection element 12 is heated. This period can be described as a heating cycle. The heating changes the electrical resistance of the detection elements 12, which in turn changes the voltage V_Out. In the example shown in FIG. 4, the voltage V_Out increases as the temperature of the detection elements 12 increases during the heating cycle. In the subsequent period 10<t<20, the detection elements 12 is no longer supplied with heating power, so that it cools down. This period can be described as a cooling cycle. Cooling in turn changes the electrical resistance of the detection elements 12, so that the voltage V_Out also changes during cooling. In the example in FIG. 4, the voltage V_Out decreases as the temperature of the detection elements 12 decreases during the cooling cycle. The units on the abscissa and ordinate have been chosen arbitrarily here; the curves are intended for illustrative purposes.

The shape of the two curves 38, 40 representing different measurement signals depends, among other things, on previously known variables such as the supply voltage V_0, the second resistor element, the material and the wall thickness of the separating wall 22 and the temperature coefficient of the detection elements 12. An initial temperature of the detection element 12 at the beginning of the heating cycle can be used as a further previously known variable, which results, for example, from the electrical resistance value of the detection element 12 at the beginning of the heating cycle. However, in addition to the predetermined variables, the course of the two curves also depends significantly on the heat flow to be detected between the detection elements 12 and the room area 12. Knowing the predetermined variables, the heat flow can be inferred from one or more measure values of a measurement signal, and thus also whether the room area 14 next to the detection elements 12 assigned to this measurement signal is currently filled with gas (e.g., air) or a liquid (e.g., liquid detergent). Knowledge of the installation height h of this detection element 12 then allows a direct conclusion to be drawn about the fill level of the liquid 15.

In FIG. 4, exemplary measure values 42-56 of the two different measurement signals are marked by dots. It can be seen that the voltage V_Out at time t1 at the beginning of the heating cycle is the same in both cases (measure value 42). The initial temperature of the detection elements 12 can be determined from this measure value 42 by knowing its temperature-dependent electrical resistance, the supply voltage and the electrical resistance value of the second resistor element. It can be assumed that the initial temperature of the detection elements 12 corresponds to a temperature of the medium in the room area 14. At time t2 during the heating cycle, the voltage values V_Out differ depending on whether or not there is liquid in the room area next to the detection element 12. The heat dissipation from the heated detection element 12 is greater if there is liquid in the room area 14 that has a lower temperature than the detection element 12. The measure value 44 or 46 can be compared with a predetermined limit value, which is defined in particular with respect to the initial temperature, in order to determine whether or not there is liquid above the installation height h of this detection element 12 in the room area 14 next to the detection element 12. The time period t2-t1 can be predefined or selected on the basis of the initial temperature of the detection element 12. It is also possible to measure the time required for a measurement signal to reach a predetermined limit value, which is defined in particular in relation to the initial temperature, in order to determine whether or not liquid is currently present in the room area 14 next to the detection element 12 above the installation height h of this detection element 12. Instead of the time period t2-t1, the time period t3-t1 or t3-t2 can also be used or instead of the measured values 44, 46, the measured values 48, 50 can be used. The measure values 48, 50 can represent a constant final temperature of the detection elements 12 at constant heating power, which depends on the heat flow and therefore also on the medium in the room area 14. The cooling behaviour of the detection elements 12 also differs depending on the medium in the room area 14, as can be seen from the measure values 52, 54. The measure values 56, 58 again represent a constant final temperature of the detection elements 12 after completion of the cooling cycle. The measure values 52, 54, 56 and/or 58 and the associated times t4, t5, t6 can also be used to infer the level of the liquid in the room area 14. It is also conceivable to compare a measurement signal or a corresponding curve with previously known reference signals or reference curves in order to determine whether or not liquid is currently present in the room area 14 next to the detection elements 12 from which the measurement signal was obtained. Other ways of evaluating the measurement signals, in particular the voltage V_Out, by the control unit 30 are also conceivable.

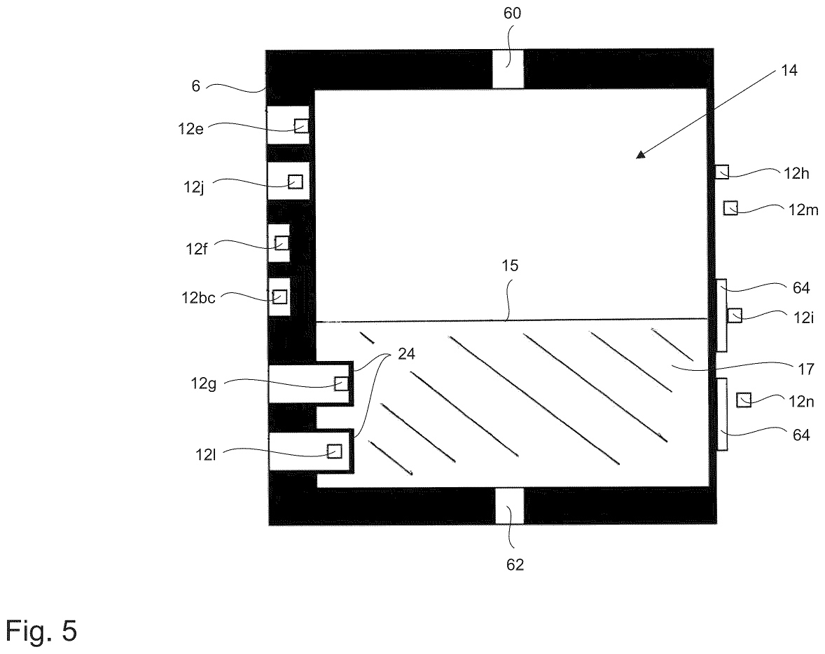

In FIG. 5, several possible arrangements of the detection elements 12 or 12e-12n are shown in relation to a room area 14. The sensor system 10 can comprise one or more detection elements 12 arranged in this way.

A detection element 12 may either be in contact with the separating wall 22 (cf. 12e-12i), or be spaced apart (cf. 12j-12n), in particular less than 5 mm, less than 4 mm, less than 3 mm, less than 2 mm or less than 1 mm. The separating wall 22 may have any desired thickness between the detection elements 12 and the room area 14. The lower the thermal conductivity of the material of the separating wall 22, the lower this thickness should also be selected. In particular, the separating wall between the detection elements 12 and the room area 14 may have a thickness of less than 5 mm, less than 4 mm, less than 3 mm, less than 2 mm or less than 1 mm.

The detection element 12 may be embedded in an outer wall of a liquid container 6 (cf. 12e, 12f, 12j, 12k), or may be arranged outside the outer wall of the liquid container 6 (cf. 12h, 12i, 12m, 12n). As shown in FIG. 5, the liquid container 6 may comprise an inlet 60 for liquid 17 connected to the room area 14 and an outlet 62 for the liquid 17 connected to the room area 14.

It is also conceivable to provide a compensating clement 64 on the separating wall 22, in particular on the outer wall of the liquid container 6, which is assigned to exactly one detection clement 12 and which in particular has a higher thermal conductivity than the material separating wall 22. The compensating element 64 can increase a heat transfer surface between the room area 14 and the detection element 12. The detection element 12i is in direct contact with the compensating element 64, while in the example of the detection element 12n there is a slight distance (e.g., in the millimetre or sub-millimetre range) between the detection element and the compensating element. If the compensating element 46 extends over several millimetres or centimetres in the height direction, it is even conceivable to use the measurement signal of the single detection element 12i or 12n, which is assigned to this compensating element 46, to distinguish three or more liquid levels from one another or even to enable continuous detection of the liquid level 15 in the area of the compensating element 46. The compensating element 46 can also be embedded in the separating wall 22 or form part of the separating wall 22.

Advantageously, at least one detection element from a plurality of detection elements is operated as a reference detection element. There are thus at least two detection elements. Advantageously, the reference detection element is arranged in an upper area of the liquid container. This area is located above the maximum fill level, so that there is generally no liquid in this area. A heat flow to the remaining medium in the liquid container is thus measured by the at least one reference detection element. This remaining medium is usually air. It would also be conceivable for the at least one reference element to determine the heat flow to the air surrounding the liquid container.

The value measured by the reference detection element is thus used as a reference in an evaluation. During the evaluation, a quotient can advantageously be formed from the measured value of the reference detection element and the measured value of one or more further detection elements. If the at least one further detection element is above the fill level, a measure value is measured with regard to a heat flow to the remaining medium, for example air. The resulting quotient in the evaluation therefore essentially corresponds to the value 1. A deviation from this value 1 therefore means that a heat flow to the liquid is taking place. The use of at least one detection element from a plurality of detection elements as a reference detection element thus results in a simpler possibility for evaluation.

According to another preferred embodiment, the sensor system comprises several detection elements connected in series. The detection elements are thus resistor elements of a voltage divider with at least one further resistor element. The current through the entire detection elements or a change in this current is used for evaluation. This design eliminates the need for a tap on the individual detection elements, which means that the sensor system can be manufactured more cost-effectively.

Furthermore, a further resistor element may be provided, which is suitable and intended to heat the at least one detection element. This at least one resistor element can be connected in series or in parallel with the at least one detection element.

It is understood that the embodiments described here can be combined with one another. Also, the sensor unit 10 need not have all of the features described with reference to the figures. Further technical effects and advantages of the invention described herein may become apparent to the skilled person when studying the present disclosure.

What is claimed is:

1. A sensor system for a liquid-carrying household appliance, wherein the sensor system comprises at least one detection element for detecting at least one heat flow and is designed to arrange the at least one detection element in the liquid-carrying household appliance next to a room area designed to hold a liquid in such a way that the at least one detection element is able to detect a heat flow between the at least one detection element and the room area which indicates a fill level of liquid in the room area.

2. The sensor system according to claim 1, wherein the sensor system is configured to arrange the at least one detection element at a predetermined height next to the room area such that the at least one detection element is able to detect the heat flow between the at least one detection element and the room area, which indicates whether the fill level of liquid falls below or exceeds the predetermined height.

3. The sensor system according to claim 1, wherein the at least one detection element is configured to be heated and/or cooled by being supplied with electrical energy and to provide a measurement signal indicating a temperature of the at least one detection element.

4. The sensor system according to claim 3, wherein at least one resistor element is provided which is configured for heating the at least one detection element, and wherein the at least one resistor element is connected in series or in parallel with the at least one detection element.

5. The sensor system according to claim 1, further comprising a printed circuit board with a main section and at least one finger-shaped extension projecting from the main section and carrying the at least one detection element.

6. The sensor system according to claim 5, wherein the at least one finger-shaped extension is adapted to extend from the main section of the printed circuit board towards the room area of the liquid-carrying household appliance and/or wherein two or more of the at least one finger-shaped extension extend substantially parallel.

7. The sensor system according to claim 5, wherein the at least one detection element is arranged on the printed circuit board and forms a first resistor element of a voltage divider with at least two resistor elements, and wherein one or more further resistor elements of the voltage divider are arranged separately from the printed circuit board.

8. The sensor system according to claim 7, wherein all the further resistor elements of the voltage divider are arranged separately from the printed circuit board.

9. The sensor system according to claim 1, wherein the at least one detection element comprises a plurality of detection elements which are connected in series.

10. The sensor system according to claim 1, further comprising a separating wall, wherein the sensor system is configured to arrange the at least one detection element in the liquid-carrying household appliance separated from the room area at least by the separating wall, and wherein the separating wall optionally forms at least a part of a liquid container enclosing the room area.

11. The sensor system according to claim 10, wherein the separating wall has at least one protrusion which is formed in a direction of the room area, and wherein the at least one detection element is arranged in the at least one protrusion.

12. The sensor system according to claim 1, further comprising a control unit arranged to receive one or more measurement signals from the at least one detection element and to determine therefrom a value indicating the at least one heat flow detected by the at least one detection element and/or the fill level of liquid in the room area.

13. The sensor system according to claim 12, wherein the control unit is configured to cause heating and/or cooling of the at least one detection element and to determine the value based on a temperature behavior of the at least one detection element indicated by the one or more measurement signals.

14. The sensor system according to claim 1, wherein the at least one detection element is configure to be operated as a reference detection element which is able to detect a heat flow between said reference detection element and the room area or an environment of the room area, and wherein said reference detection element is not intended to detect a heat flow between said reference detection element and the liquid held in the room area.

15. The sensor system of claim 1, wherein the liquid-carrying household appliance is a washing machine.

16. The sensor system of claim 1, wherein the liquid is a washing liquid.

17. A liquid-carrying household appliance comprising the sensor system according to claim 1.

18. The liquid-carrying household appliance of claim 17, wherein the liquid-carrying household appliance is a washing machine. liquid, in particular washing liquid, in the room area.
